(19) United States
(12) Patent Application Publication
(10) Pub. No.: US 2002/0026516 A1
(43) Pub. Date: Feb. 28, 2002

(54) System and method for allowing selectively information retrieval and chat services using single data entry section

(76) Inventor: Hwan Soo Yoo, Suwon (KR)

Correspondence Address: Timothy J. Keefer, Wildman, Harrold, Allen & Dixon, 225 West Wacker Drive, Chicago, IL, 60606, US

(21) Appl. No.: 09/945,138

(22) Filed: Aug. 31, 2001

(30) Foreign Application Priority Data
Aug. 31, 2000 (KR) 2000-50966

(51) Int. Cl. G06F 15/16

(52) U.S. Cl. 709/227

(57) ABSTRACT

Disclosed are a system and method for discriminating data entered in a single data entry section provided on a screen of Web browser, and selectively allowing an information retrieval service or a chat service, the method comprising the processes of providing a single data entry section on the screen during the activation of the web browser to allow a user to enter data thereon; deciding whether URL (Uniform Resource Locator) data is presented in the entered data; deciding the entered data as chat data in the absence of the URL data, and providing a chat-dedicated section on the screen to allow the chat data to be displayed thereon; estimating whether data subsequent to the URL data is presented, in the presence of the URL data; and determining, in the presence of the subsequent data, the entered data as chat data and displaying it on the chat-dedicated section; and otherwise, deciding the entered data as URL data and attempting connecting to a host corresponding to the URL data.

### FIELD OF THE INVENTION

The present invention relates to a network-based data transmitting/receiving system; and, more particularly, to a system and method which allow data communication between clients or between a client and a host through the use of a single data entry section provided on a Web browser screen.

### BACKGROUND OF THE INVENTION

Web browsers have allowed people to easily navigate the Internet to a website on the network. One way the web browsers to connect a user to a website is to receive a URL of the website from the user in a data entry section in the browser screen.

The URL, which uniquely identifies the “address” of a file (resource) accessible on the Internet, includes an Internet protocol, a domain name and/or file directory. Common Internet protocols are FTP (File transfer protocol), Telnet, HTTP (Hypertext Transfer Protocol), News, Gopher and Files.

When the user connects to a web site that provides a chatting service, the website usually transmits a web page having a window dedicated to chatting. In order to access a different website while chatting in the current website, the user needs to type in a new URL in the URL entry section of the web browser screen. The URL entry section is usually provided on the top of the browser screen in a tool bar along with other tool bars. This user interface area limits the size of a web page that can be displayed at one time. Thus, there is a need to reduce the size of the user interface, including the URL entry section, to allow more area for displaying web pages. However, simple removable of a user interface area causes inconveniences to the users.

### SUMMARY OF THE INVENTION

It is, therefore, a primary object of the present invention to provide a system and method which are capable of discriminating data entered in a single data entry section provided on a screen of Web browser, and selectively allowing an information retrieval service or a chat service, thereby making the utmost use of the Web browser screen with a restricted size.

In accordance with a preferred embodiment of the present invention, there is provided to a system for discriminating data entered on a screen of a Web browser to selectively allow an information retrieval or chat service using a communications network, which comprising: means for storing information associated with a type of URL (Uniform Resource Locator) data representing the location of each host; means for providing a single data entry section on the screen during the activation of the web browser; means for determining whether data entered on the single data entry section is the URL data for information retrieval or character data for chat, based on the type information stored in the storing means; means for executing connection to a host corresponding to the URL data using the Web browser, when the entered data is determined as the URL data at the determining means; and means for providing a character data display section on the screen and displaying the character data thereon, when the entered data is determined as the character data at the determining means.

In accordance with another preferred embodiment of the present invention, there is provided to a method for discriminating data entered on a screen of a Web browser to selectively allow an information retrieval or chat service using a communications network, comprising the following steps: (a) providing a single data entry section on the screen during the activation of the web browser to allow a user to enter data thereon; (b) determining whether an enter key is depressed after the entrance of the data; and if so, deciding whether URL (Uniform Resource Locator) data is presented in the entered data; (c) deciding the entered data as character data in the absence of the URL data, and providing a character data display section on the screen to allow the character data to be displayed thereon; (d) estimating whether data subsequent to the URL data is presented, in the presence of the URL data; and (e) determining, in the presence of the subsequent data, the entered data as character data and displaying the character data on the character data display section; and otherwise, deciding the entered data as URL data and attempting connecting to a host corresponding to the URL data using the Web browser; and wherein the URL data includes a first set of data representing an Internet application protocol for each host and a second set of data representing a property and a lower address of the each host, wherein the lower address is alphanumeric data representing hierarchical location information of the host in sequential order starting from a symbol “/” after the second set of data.

### BRIEF DESCRIPTIONS OF THE DRAWINGS

The above and other objects and features of the present invention will become apparent from the following description of preferred embodiments given in conjunction with the accompanying drawings, in which:

FIG. 1 is a schematic block diagram of a web browsing system in accordance with a preferred embodiment of the present invention;

FIG. 2 is a detailed block diagram of the data analyzing block shown in FIG. 1;

FIG. 3 is an illustrative pictorial view of the Web browser screen in which the single data entry section is provided in accordance with a preferred embodiment of the present invention;

FIGS. 4a and 4b depict illustrative diagrams that will be used to describe the case data entered on the single data entry section is URL data and chat data, respectively; and

FIG. 5 is a flow chart that will be used to describe a method for discriminating if the entered data is the URL data or the chat data, in accordance with another preferred embodiment of the present invention.

### DETAILED DESCRIPTION OF THE PRESENT INVENTION

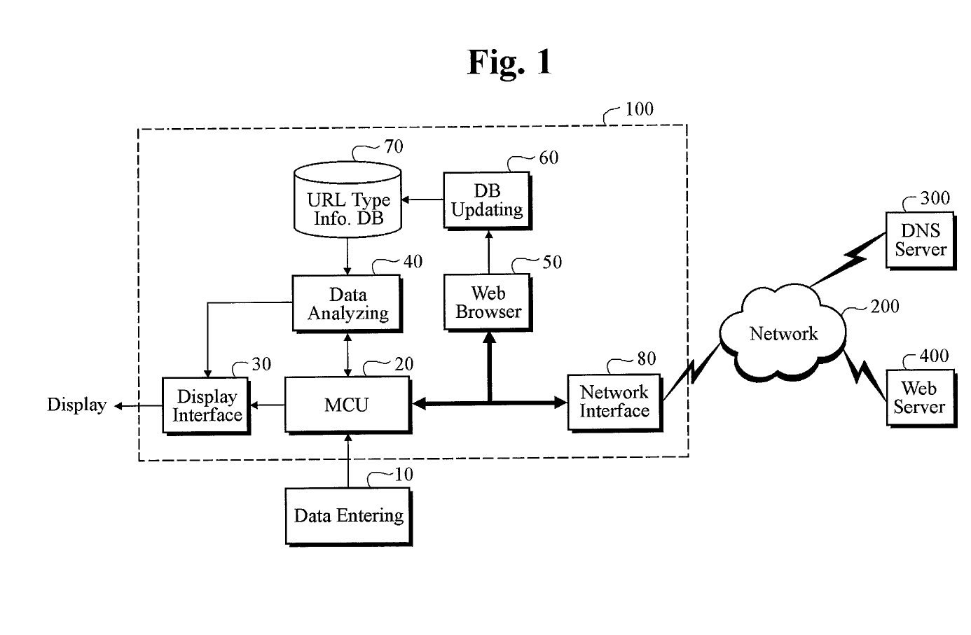

Referring to FIG. 1, there is a schematic block diagram of a web browsing system in accordance with a preferred embodiment of the present invention.

In FIG. 1, a user computer, which is indicated by reference numeral 100, incorporates the web browsing system of the present invention therein. A domain name system (DNS) server 300, which is the way that Internet domain names are located and translated into Internet Protocol addresses, stores many different types of URL information therein. A web server 400 is a conventional one and therefore a further description thereof is omitted herein.

The user computer 100 includes a data entering block 10 to which data is entered through a data input device such as a keyboard or mouse, a display interface 30 via which display data is transmitted a display (not shown), a data analyzing block 40 for analyzing input data, a web browser 50 for navigating the web, a database (DB) updating block 60, a URL type information DB 70, a network interface 80 for communication with a communications network 200 such as the Internet, and a main control unit (MCU) 20 for controlling each of these components.

The data analyzing block 40 in accordance with a preferred embodiment of the present invention determines whether data inputted from the data entering block 10 is destination URL information or chatting messages. An exemplary URL is “http://www.gomid.com/ABC.asp”. For the purpose of this specification, in the destination URL information, the first string (i.e., “http://www” or “www”) is referred to as prefix data, the second string (i.e., “gomid”) is referred to as destination data, and the third string (i.e., “.com”) is referred to as suffix data. The prefix data can take the form of “ftp://www.”, “telnet://www.”, “news://www.”, “gopher://www.”, “file://www.” and the like. The suffix data includes “org”, “nom”, “net”, “co.kr” and the like. A string that follows the suffix data (i.e., /ABC.asp) is a directory in the server computer and is the default page in that directory (which, on the computer, happens to be named index.html).

The URL type information DB 70 stores varying forms of the prefix data, suffix data and directory data of URLs. The DB updating block 60 connects to the DNS server 300 via the network interface 80 and the network 200 using a DNS protocol under the control of the MCU 20 when the web browser 50 is run. It downloads information on the types of URLs for updating stored URL types in the URL type information DB 70. The update of the URL type information DB 70 may be automatically performed with the downloaded information from the DNS server 300, when the user executes a program incorporating the present invention.

The data analyzing block 40 determines if an input is a URL or chatting message by analyzing the structure of the input and transmits the result to the display interface 30 or the MCU 20.

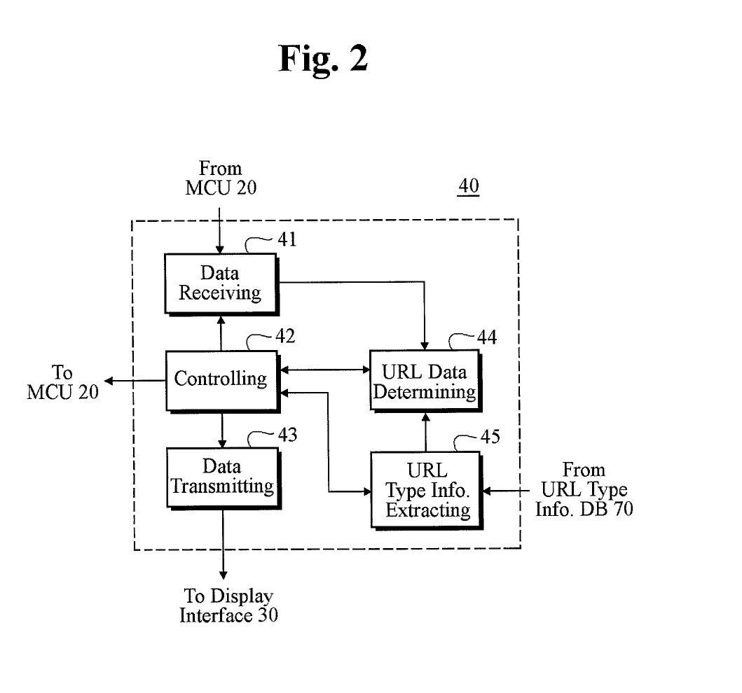

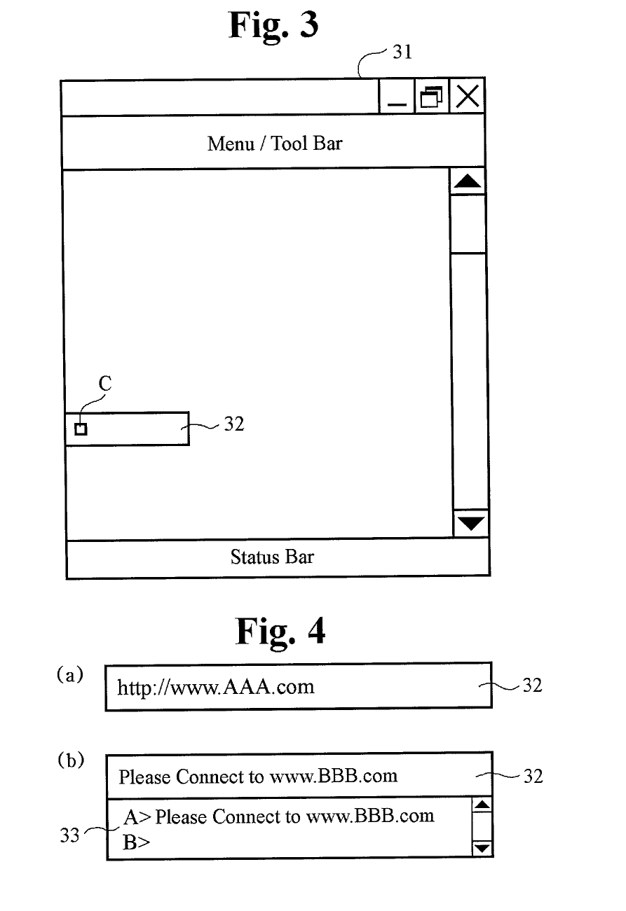

FIG. 2 is a detailed block diagram of the data analyzing block 40 shown in FIG. 1. FIG. 3 is an illustrative pictorial view of a Web browser screen in which a single data entry section is provided in accordance with a preferred embodiment of the present invention.

As shown in FIG. 2, the data analyzing block 40 of the present invention includes a data receiving unit 41, a data transmitting unit 43, a URL data determining unit 44, a URL type information extracting unit 45 and a controlling unit 42 for controlling each of the units 41, 43, 44, and 45.

If the user writes data in the single data entry section 32, using a data input device such as a keyboard, the MCU 20 forwards the input to the data analyzing block 40. Then, the URL type information extracting unit 45 in the data analyzing block 40 shown in FIG. 2 extracts URL types from the URL type information DB 70, under the control of the controlling unit 42, and transmits them to the URL data determining unit 44.

Specifically, the controlling unit 42 directs the input, received by the data receiving unit 41 from the MCU 20, to be compared with URL type data that are provided from URL type information extracting unit 45 at the URL data determining unit 44.

For example, as shown in FIG. 4a, if prefix data “http://www.” and suffix data “.com” are found and there are no other strings before and after to the prefix and the suffix data respectively, the URL data determining unit 44 determines the input as a URL and transmits it to the controlling unit 42. The controlling unit 42 transmits the URL to the MCU 20, which activates the web browser 50 to navigate to a web server of the URL.

As shown in FIG. 4b, on the other hand, if the input contained strings either before a prefix data or after a suffix data, the URL data determining unit 44 would determine the input as a chatting message and transmits it to the controlling unit 42, which then transmits the message to the display interface 30 shown in FIG. 1 through the data transmitting unit 43 so that the chatting message can be displayed in the conversation section 33 on the Web browser screen 31.

Additionally, when an input is determined to be a URL, the string “http” may be attached as default before the URL is transmitted to the MCU 20.

In accordance with the present invention, the conversation section 33 is activated only when the input is determined to be a chatting message, and is automatically inactivated when the input a URL, in order to present a browser screen 31 without too many distracting windows.

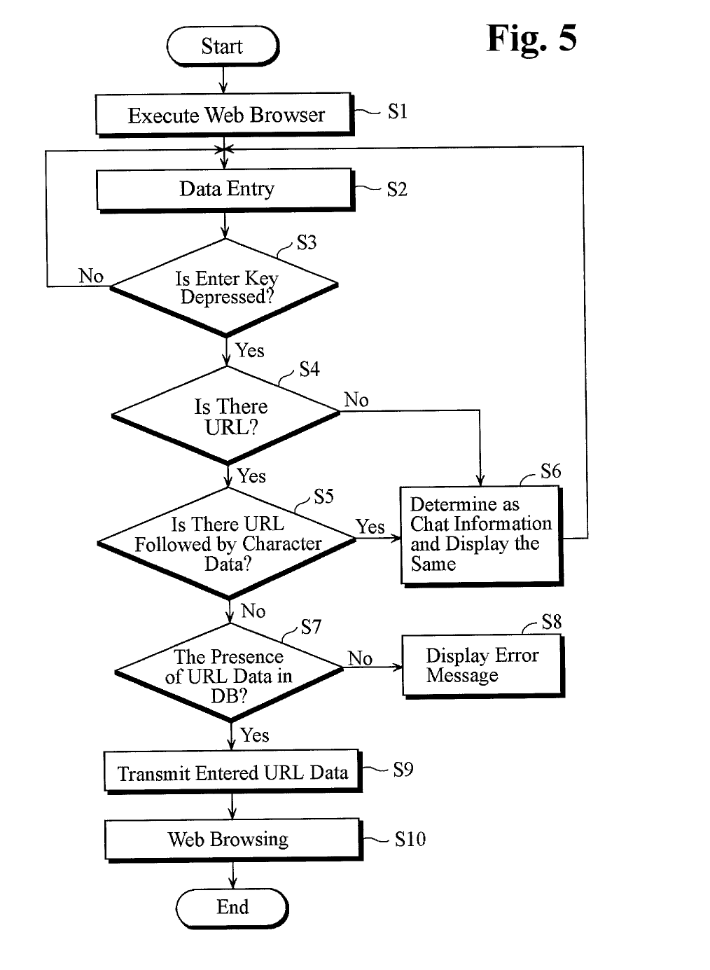

FIG. 5 is a flow chart for determining an input is a URL or a chatting message in accordance with another preferred embodiment of the present invention.

At step S1, if the user executes a web browser 50 installed on the user's computer 100, a single data entry section 32 of the present invention appears on the Web browser screen 31 with a cursor C blinking, as shown in FIG. 3. At step S2 the user types certain strings of alphanumeric characters in the single data entry section 32 using a keyboard. At step S3 it is checked whether the Enter key was pressed.

If the Enter key was pressed, at step S4 it is checked whether the inputted strings include a URL. As explained above, the presence or absence of a URL is determined by looking to see if any part of the strings is in the form of a prefix, a suffix and/or a directory data that are stored in the URL type information DB 70.

If no prefix and suffix are found in the known related manner, the input strings are determined as a chatting message at step S6, which is displayed on a conversation window that is activated in response. On the other hand if a URL is found, it is further checked if there are other alphanumerical characters either before or after the URL at step S5. If so, at step S6 it is determined that the input is a chatting message and a conversation window is activated to display the message. At step S5 if there are no other characters subsequent to the URL, it determines at step S7 whether the URL is a typical one and whether its pattern is present in the URL type information DB 70.

If the pattern of the URL is not one that is acceptable, an error message is displayed on the Web browser screen 1 at step S8. If the URL is an acceptable one after being compared with standard patterns for a URL that have been stored in the URL type information DB 70, the URL is transmitted to the MCU 20 at step S9. At step S10, the MCU 20, in response, activates the web browser 50 to connect to a web server 400 corresponding to the URL through the network 200.

As demonstrated above, the present invention provides on a Web browser screen a single data entry section on which URL data or chat data is inputted, thereby making the utmost use of the Web browser screen having a restricted size, which, in turn, is useful for a potable communications terminal built in web functions. Furthermore, the present invention has the ability to selectively enter the URL data or the chat data on the single data entry section, thereby allowing an information retrieval or chat service in the single data entry section, which in turn, makes it possible to improve the convenience of the user.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A system for discriminating data entered on a screen of a Web browser to selectively allow an information retrieval or chat service using a communications network, which comprising:
means for storing information associated with a type of URL (Uniform Resource Locator) data representing the location of each host;
means for providing a single data entry section on the web browser screen;
means for determining whether data entered in the single data entry section is a URL or a chatting message based on the structure of the input data;
means for executing connection to a web site associated with the URL if the input data entered in the signal data entry section is determined to be a URL; and
means for displaying the chatting message on the web browser screen if the input data entered in the single data entry section is determined to be not a URL.

2. The system of claim 1, which further comprises means for downloading newly registered URL data from a domain name server which stores therein the newly registered URL data through the network and the Web browser, and updating the storing means with the downloaded data.

3. The system of claim 2, wherein the update of the storing means by the updating means is performed during the activation of the Web browser.

4. The system of claim 3, wherein the URL type information stored in the storing means includes a first set of data representing an Internet application protocol for each of the hosts and a second set of data representing a property of each of the hosts; and
the determining means includes:
means for receiving the entered data;
means for deciding whether any one of the first set of data and any one of the second set of data are presented in the entered data; and
means, in the presence of the any one of the first set of data and the any one of the second set, for estimating whether data subsequent to any one of the second set of data and/or a lower address of the host is presented; and, if so, judging the entered data as the character data; and
wherein the lower address is alphanumeric data representing hierarchical location information of the host in sequential order starting from a symbol “/” after the second set of data.

5. The system of claim 4, wherein the deciding means includes means for regarding the entered data as the character data, when no the beginning data of the entered data is contained in the first set of data of the URL data.

6. The system of claim 1, wherein the character data display section is activated only when the entered data is determined as the character data by the determining means.

7. A method for discriminating data entered on a screen of a Web browser to selectively allow an information retrieval or chat service using a communications network, comprising the following steps:
(a) providing a single data entry section on the screen during the activation of the web browser to allow a user to enter data thereon;
(b) determining whether an enter key is depressed after the entrance of the data; and if so, deciding whether URL (Uniform Resource Locator) data is presented in the entered data;
(c) deciding the entered data as character data in the absence of the URL data, and providing a character data display section on the screen to allow the character data to be displayed thereon;
(d) estimating whether data subsequent to the URL data is presented, in the presence of the URL data; and
(e) determining, in the presence of the subsequent data, the entered data as character data and displaying the character data on the character data display section; and otherwise, deciding the entered data as URL data and attempting connecting to a host corresponding to the URL data using the Web browser; and
wherein the URL data includes a first set of data representing an Internet application protocol for each host and a second set of data representing a property and a lower address of the each host, wherein the lower address is alphanumeric data representing hierarchical location information of the host in sequential order starting from a symbol “/” after the second set of data.

8. The method of claim 7, wherein the character data display section is activated only when the entered data is determined as the character data at the determining means.

9. The method of claim 7, wherein the step (c) includes the steps of:
(c1) extracting the first set of data and the second set of data from the URL data; and
(c2) deciding whether any one of the first set of data is presented in the entered data; and if so, determining whether any one of the second set of data is presented in the entered data.

10. The method of claim 7, wherein the step (e) includes the step of:
(e1) determining whether the URL data is erroneous; and if so, displaying error message on the screen.

11. The method of claim 9, wherein the step (c) includes the step of:
(c3) determining the entered data as the character data, when no the beginning data of the entered data is contained in the first set of data of the URL data.
